(19) United States
(12) Patent Application Publication
(10) Pub. No.: US 2024/0324043 A1
(43) Pub. Date: Sep. 26, 2024

(54) COMMUNICATION APPARATUS, COMMUNICATION METHOD, AND STORAGE MEDIUM

(71) Applicant: CANON KABUSHIKI KAISHA, Tokyo (JP)

(72) Inventor: TOMOYASU SOMA, Kanagawa (JP)

(21) Appl. No.: 18/733,094

(22) Filed: Jun. 4, 2024

Related U.S. Application Data
(63) Continuation of application No. PCT/JP2022/041934, filed on Nov. 10, 2022.

(30) Foreign Application Priority Data
Dec. 6, 2021 (JP) 2021-197844

(51) Int. Cl. H04W 76/15; H04W 60/04; H04W 84/12

(52) U.S. Cl. CPC H04W 76/15; H04W 60/04; H04W 84/12

(57) ABSTRACT

A communication apparatus capable of establishing a plurality of links with another communication apparatus in parallel receives a request including information about a link establishment and transmits, in a case where the received request does not include information about an assignment of a Traffic Identifier (TID) indicating data priority, a response including the information about the TID assignment.

### CROSS-REFERENCE TO RELATED APPLICATIONS

This application is a Continuation of International Patent Application No. PCT/JP2022/041934, filed Nov. 10, 2022, which claims the benefit of Japanese Patent Application No. 2021-197844, filed Dec. 6, 2021, both of which are hereby incorporated by reference herein in their entireties.

### BACKGROUND OF THE INVENTION

### Field of the Invention

The present invention relates to a communication apparatus for performing wireless communication, a communication method, and a storage medium.

### Background Art

In recent years, wireless communication technologies such as wireless Local Area Networks (LANs) are increasingly being developed. The Institute of Electrical and Electronic Engineers (IEEE) 802.11 standard series is known as a major communication standard for wireless LANs. The IEEE 802.11 standard series includes the IEEE 802.11a/b/g/n/ac/ax standards. For example, IEEE 802.11ax which is the latest standard standardizes a technique not only for achieving a throughput as high as 9.6 gigabits/sec. (Gbps) but also for improving the transmission rate under a congested situation by using orthogonal frequency-division multiple access (OFDMA) (see PTL 1).

A task group called IEEE 802.11be has been established as a successor standard aiming for further improvements of the throughput, frequency usage efficiency, and communication latency.

For the IEEE 802.11be standard, Multi-Link communication is currently being studied in which one access point (AP) and one station (STA) establish a plurality of links via the 2.4 GHz, 5 GHZ, and 6 GHz frequency bands to perform simultaneous communication.

### CITATION LIST

### Patent Literature

PTL 1: Japanese Patent Application Laid-Open No. 2018-050133

In Multi-Link communication being studied for the introduction to IEEE 802.11be, associating links to be established with (assigning them to) a Traffic Identifier (TID) as an identifier of data priority is currently being studied. Assigning TID values to links in advance enables suitably selecting a link to be used for data communication according to the data priority.

The TID assignment is performed in such a way that one communication apparatus (Non-Access Point (AP) Multi-Link Device (MLD)) issues a TID assignment request to another communication apparatus (AP MLD) which receives and accepts the request.

However, there has conventionally been no protocol which assumes a case where no TID assignment request is issued from the Non-AP MLD. Therefore, TID values may not be suitably assigned to links.

### SUMMARY OF THE INVENTION

The present invention is directed to providing a method for suitably assigning TID values to links.

According to an aspect of the present invention, a communication apparatus capable of establishing a plurality of links with another communication apparatus in parallel includes a reception unit configured to receive a request including information about a link establishment, and a transmission unit configured to transmit a response to the request received by the reception unit. In a case where the request received by the reception unit does not include information about an assignment of a Traffic Identifier (TID) indicating data priority, the transmission unit transmits a response including the information about the assignment of the TID.

According to another aspect of the present invention, a communication apparatus capable of establishing a plurality of links with another communication apparatus in parallel includes a transmission unit configured to transmit a request including information about a link establishment but not including information about an assignment of a TID indicating data priority, a reception unit configured to receive a response to the request transmitted by the transmission unit, and a communication unit configured to communicate with the other communication apparatus based on the information about the assignment of the TID included in the response received by the reception unit.

Further features of the present invention will become apparent from the following description of exemplary embodiments with reference to the attached drawings.

### BRIEF DESCRIPTION OF THE DRAWINGS

FIG. 1 illustrates an overall configuration of a network according to the present invention.

FIG. 2 illustrates a hardware configuration of a communication apparatus according to the present invention.

FIG. 3 illustrates a functional configuration of a communication apparatus according to the present invention.

FIG. 4 illustrates an overview of Multi-Link communication.

FIG. 5 is a sequence diagram illustrating a link establishment according to a first exemplary embodiment.

FIG. 6 illustrates a frame format according to the present invention.

FIGS. 7A, 7B, and 7C illustrate frame formats according to the present invention.

FIG. 8 is a flowchart illustrating an operation of a communication apparatus (Access Point (AP) Multi-Link Device (MLD)) according to the first exemplary embodiment.

FIG. 9 is a flowchart illustrating an operation of a communication apparatus (Non-AP MLD) according to the first exemplary embodiment.

FIG. 10 is a sequence diagram illustrating a link establishment according to a second exemplary embodiment.

FIG. 11 is a flowchart illustrating an operation of a communication apparatus (AP MLD) according to the second exemplary embodiment.

FIG. 12 is a flowchart illustrating an operation of a communication apparatus (Non-AP MLD) according to the second exemplary embodiment.

FIG. 13 is a sequence diagram illustrating a link establishment according to the third exemplary embodiment.

FIG. 14 is a flowchart illustrating an operation of a communication apparatus (AP MLD) according to the third exemplary embodiment.

FIG. 15 is a flowchart illustrating an operation of a communication apparatus (Non-AP MLD) according to the third exemplary embodiment.

FIG. 16 illustrates a frame body of an Association Request according to the present invention.

FIGS. 17A and 17B illustrate a list of a Status Code used for the frame format according to the present invention.

### DESCRIPTION OF THE EMBODIMENTS

Exemplary embodiments of the present invention will be described in detail below with reference to the accompanying drawings. Configurations described in the following exemplary embodiments are merely examples, and the present invention is not limited to the illustrated configurations.

### (Configuration of Wireless Communication System)

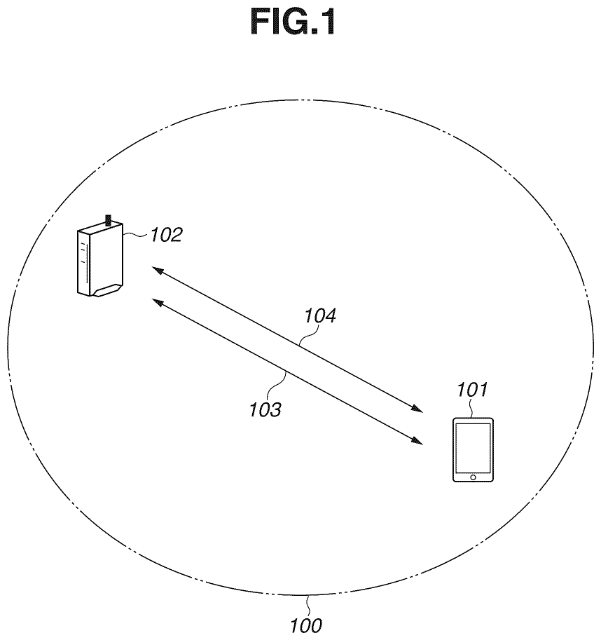

FIG. 1 illustrates a configuration of a network to be participated in by a communication apparatus 101 (hereinafter referred to as a Non-Access Point (AP) Multi-Linked Device (MLD) 101) according to the present exemplary embodiment. A communication apparatus 102 (hereinafter referred to as an AP MLD 102) is an AP having a role of building a wireless network 100. The AP MLD 102 can communicate with the Non-AP MLD 101. The present exemplary embodiment applies to the Non-AP MLD 101 and the AP MLD 102.

Each of the Non-AP MLD 101 and the AP MLD 102 is capable of performing wireless communication conforming to the Institute of Electrical and Electronics Engineers (IEEE) 802.11be (EHT) standard. The Non-AP MLD 101 and the AP MLD 102 can communicate with each other by using frequencies in the 2.4 GHZ, 5 GHZ, and 6 GHz frequency bands. Frequency bands used by these communication apparatuses are not limited thereto. The communication apparatuses may use, for example, the 60 GHz frequency band. The Non-AP MLD 101 and the AP MLD 102 can communicate with each other by using the 20 MHz, 40 MHZ, 80 MHz, 160 MHz, and 320 MHz bandwidths. Bandwidths used by these communication apparatuses are not limited thereto. The communication apparatuses may use, for example, the 240 MHz and 4 MHz bandwidths.

The Non-AP MLD 101 and the AP MLD 102 can implement multi-user (MU) communication which multiplexes signals of a plurality of users by performing orthogonal frequency-division multiple access (OFDMA) communication conforming to the IEEE 802.11be standard. In OFDMA communication, some of division frequency bands (resource unit (RU)) are assigned not to overlap with different STAs, and the carrier of each STA are orthogonal from each other. This enables the AP to communicate with a plurality of STAs in parallel in specified band widths.

Generally, electric waves having different frequencies reach different distances. It is known that an electric wave having a lower frequency provides a larger diffraction and reaches a longer distance, and that an electric wave having a higher frequency provides a smaller diffraction and reaches a shorter distance. An electric wave having a low frequency diffracts an obstacle while an electric wave having a high frequency has high rectilineal property and hardly diffracts an obstacle. Meanwhile, the 2.4 GHz frequency is often used by other apparatuses. A micro wave oven is known to generate an electric wave in the same frequency band. An electric wave generated by the same apparatus provides different intensities or different signal-to-noise (SN) ratios for different frequency bands depending on the location or environment where the apparatus is installed.

In addition to the IEEE 802.11be standard, the Non-AP MLD 101 and the AP MLD 102 may conform to legacy standards that are earlier than the IEEE 802.11be standard. More specifically, the Non-AP MLD 101 and the AP MLD 102 may conform to at least one of IEEE 802.11a/b/g/n/ac/ax standards. Alternatively, the Non-AP MLD 101 and the AP MLD 102 may conform to the standard as a successor of IEEE 802.11be.

In addition to the IEEE 802.11 standard series, the Non-AP MLD 101 and the AP MLD 102 may conform to other communication standards, such as Bluetooth®, near field communication (NFC), ultra wide band (UWB), ZigBee, and multi band OFDM alliance (MBOA).

Examples of UWB include wireless universal serial bus (USB), Wireless 1394, and WiNET. The Non-AP MLD 101 and the AP MLD 102 may conform to wired communication standards such as a wired LAN.

Specific examples of the AP MLD 102 include a wireless LAN router and a personal computer (PC), and the present invention is not limited thereto. The AP MLD 102 may be an information processing apparatus, such as a wireless chip, capable of performing wireless communication conforming to the IEEE 802.11be standard. Specific examples of the Non-AP MLD 101 include cameras, tablet computers, smart phones, PCs, mobile phones, video cameras, head sets, and printers, and the present invention is not limited thereto. The Non-AP MLD 101 may be an information processing apparatus, such as a wireless chip, capable of performing wireless communication conforming to the IEEE 802.11be standard.

The Non-AP MLD 101 and the AP MLD 102 establish a link via a plurality of frequency channels and perform Multi-Link communication. The IEEE 802.11 series standard defines the band width of each frequency channel as 20 MHz. The frequency channels are defined in the IEEE 802.11 series standard. The IEEE 802.11 series standard defines a plurality of frequency channels in each of the 2.4 GHZ, 5 GHZ, 6 GHZ, and 60 GHz frequency bands. The 40 MHz or higher bandwidth may be used in one frequency channel through bonding with an adjacent frequency channel.

For example, the AP MLD 102 is capable of establishing a link to communicate with the Non-AP MLD 101 via a first frequency channel in the 2.4 GHz band. In parallel with this communication, the Non-AP MLD 101 is capable of establishing a link to communicate with the AP MLD 102 via a second frequency channel in the 5 GHz band. In this case, the Non-AP MLD 101 performs Multi-Link communication to maintain a second link via the second frequency channel in parallel with the link via the first frequency channel. The AP MLD 102 establishes links with the Non-AP MLD 101 via a plurality of frequency channels in this way, making it possible to improve the throughput in communication with the Non-AP MLD 101.

In Multi-Link communication between communication apparatuses, a plurality of links using different frequency bands may be established. For example, the Non-AP MLD 101 may establish a link in each of the 2.4 GHz, 5 GHZ, and 6 GHz bands. Alternatively, the Non-AP MLD 101 may establish links via a plurality of different frequency channels included in the same frequency band.

For example, a 6-channel link in the 2.4 GHz band may be established as a first link, and a 1-channel link in the 2.4 GHz band may be established as a second link.

Links in the same frequency band and links in different frequency bands may be established at the same time. For example, the Non-AP MLD 101 may be able to establish a 1-channel link in the 2.4 GHz band and a 149-channel link in the 5 GHz band in addition to the 6-channel first link in the 2.4 GHz band. Even in a case where a certain band is congested, the Non-AP MLD 101 and the AP MLD 102 can establish communication with the Non-AP MLD 101 in another band by establishing a plurality of connections using different frequencies. This enables preventing throughput degradation and communication delay in communication with the Non-AP MLD 101.

Although the wireless network in FIG. 1 includes one AP MLD 102 and one Non-AP MLD 101, the numbers and configurations of the AP MLDs 102 and the Non-AP MLDs 101 are not limited thereto. For example, one Non-AP MLD 101 may be added to the wireless network in FIG. 1. In this case, the frequency band for each link to be established, the number of links, and the frequency band are not cared.

In Multi-Link communication, the AP MLD 102 and the Non-AP MLD 101 transmit/receive data with each other via a plurality of links.

The AP MLD 102 and the Non-AP MLD 101 may be able to perform Multiple-Input And Multiple-Output (MIMO) communication. In this case, the AP MLD 102 and the Non-AP MLD 101 have a plurality of antennas, and one apparatus transmits different signals from respective antennas by using the same frequency channel. The reception side simultaneously receives all signals arriving from a plurality of streams through a plurality of antennas and separates and decodes the signals of these streams. By performing MIMO communication in this way, the AP MLD 102 and the Non-AP MLD 101 can communicate a larger amount of data in the same time duration than that in a case where MIMO communication is not performed. In Multi-Link communication, the AP MLD 102 and the Non-AP MLD 101 may perform MIMO communication in some of links.

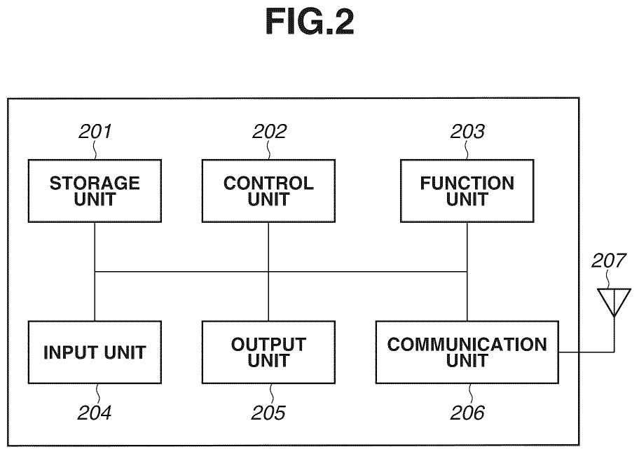

FIG. 2 illustrates an example of a hardware configuration of the Non-AP MLD 101 according to the present exemplary embodiment. The Non-AP MLD 101 includes a storage unit 201, a control unit 202, a function unit 203, an input unit 204, an output unit 205, a communication unit 206, and an antenna 207. The Non-AP MLD 101 may include a plurality of antennas.

The storage unit 201 including one or more memories, such as a read only memory (ROM) and a random access memory (RAM), stores computer programs for performing various operations (described below) and various information, such as communication parameters for wireless communication. Storage media applicable as the storage unit 201 may include not only the ROM and RAM but also a flexible disk, hard disk, optical disk, magneto-optical disk, compact disc read only memory (CD-ROM), compact disc recordable (CD-R), magnetic tape, nonvolatile memory card, and digital versatile disc (DVD). The storage unit 201 may also include a plurality of different memories.

The control unit 202 includes, for example, one or more processors, such as a central processing unit (CPU) and a micro processing unit (MPU), and totally controls the Non-AP MLD 101 by executing computer programs stored in the storage unit 201. The control unit 202 may totally control the Non-AP MLD 101 through the collaboration between the computer programs stored in the storage unit 201 and an operating system (OS). The control unit 202 also generates data and signals (wireless frames) to be transmitted in communication with other communication apparatuses.

The control unit 202 may also include a plurality of processors such as multi-core processors and control the entire Non-AP MLD 101 by using the plurality of processors.

The control unit 202 also controls the function unit 203 to perform predetermined processing, such as wireless communication, imaging, printing, and projection. The function unit 203 is a hardware component used for the Non-AP MLD 101 to perform predetermined processing.

The input unit 204 receives various operations from the user. The output unit 205 outputs various types of information to the user via a monitor screen or a speaker. Information output by the output unit 205 may include display on the monitor screen, an audio output to the speaker, and a vibratory output. The input unit 204 and the output unit 205 may be implemented as a single module like a touch panel. Each of the input unit 204 and the output unit 205 may also be integrated with the Non-AP MLD 101 or separated therefrom.

The communication unit 206 controls wireless communication conforming to the IEEE 802.11be standard. The communication unit 206 may also control wireless communication conforming to other IEEE 802.11 series standards in addition to the IEEE 802.11be standard, and control wired communication such as a wired LAN. The communication unit 206 controls the antenna 207 to transmit/receive wireless communication signals generated by the control unit 202.

If the Non-AP MLD 101 conforms to the NFC or Bluetooth® standard in addition to the IEEE 802.11be standard, the control unit 202 may control wireless communication conforming to these communication standards. In a case where the Non-AP MLD 101 can perform wireless communication conforming to a plurality of communication standards, the Non-AP MLD 101 may include different communication units and different antennas conforming to these communication standards. The Non-AP MLD 101 communicates image data, document data, and video data with the AP MLD 102 via the communication unit 206. The antenna 207 may be configured as a separate unit of the communication unit 206 or integrated with the communication unit 206 as one module.

The antenna 207 is capable of performing communication in the 2.4 GHz, 5 GHZ, and 6 GHz bands. While the Non-AP MLD 101 has one antenna according to the present exemplary embodiment, the Non-AP MLD 101 may have three different antennas. Alternatively, the Non-AP MLD 101 may have a different antenna for each frequency band. In a case where the Non-AP MLD 101 has a plurality of antennas, the Non-AP MLD 101 may include communication units 206 supporting these antennas.

Although the AP MLD 102 has a hardware configuration similar to that of the Non-AP MLD 101, the present invention is not limited thereto. For example, the configurations of the input unit 204 and the output unit 205 may be different between the AP MLD 102 and the Non-AP MLD 101.

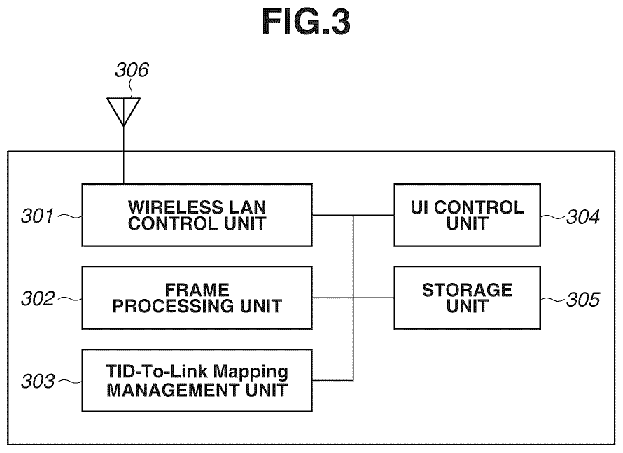

FIG. 3 is a block diagram illustrating a functional configuration of the Non-AP MLD 101 according to the present exemplary embodiment. Although the AP MLD 102 has a configuration similar to that of the Non-AP MLD 101, the configuration of the AP MLD 102 may be partly different. In this case, the Non-AP MLD 101 includes a wireless LAN control unit 301. The number of wireless LAN control units is not limited to one but two or more than two. The Non-AP MLD 101 further includes a frame processing unit 302, a TID-To-Link Mapping management unit 303, a user interface (UI) control unit 304, a storage unit 305, and a wireless antenna 306.

The wireless LAN control unit 301 includes an antenna and a circuit for transmitting/receiving wireless signals to/from another wireless LAN apparatus, and programs for controlling the antenna and the circuit. The wireless LAN control unit 301 controls wireless LAN communication based on frames generated by the frame processing unit 302 conforming to the IEEE 802.11 standard series.

The frame processing unit 302 processes wireless control frames transmitted/received by the wireless LAN control unit 301. The contents of wireless control generated and analyzed by the frame processing unit 302 may be restricted based on settings stored in the storage unit 305 or changed by user settings from the UI control unit 304. Generated frame information is transmitted to the wireless LAN control unit 301 and then transmitted to the partner communication apparatus. The frame information received by the wireless LAN control unit 301 is transferred to the frame processing unit 302 and then analyzed.

The TID-To-Link Mapping management unit 303 manages which TID is associated with which link. A TID is an identifier indicating the priority of data to be used for the purpose of quality of service (QOS). There are eight different values of TID (TID values) ranging from “0” to “7”. Some TID values out of the eight TID values are used to send video and voice data, for example. Each TID is assigned to at least one link.

The UI control unit 304 includes hardware components related to user interfaces such as a touch panel and buttons for receiving user operations on the Non-AP MLD 101, and programs for controlling these hardware components. The UI control unit 304 also has a function of displaying images or a function of presenting audio output information to the user.

The storage unit 305 is a storage device that may include a ROM and a RAM for storing programs and data on which the Non-AP MLD 101 operates.

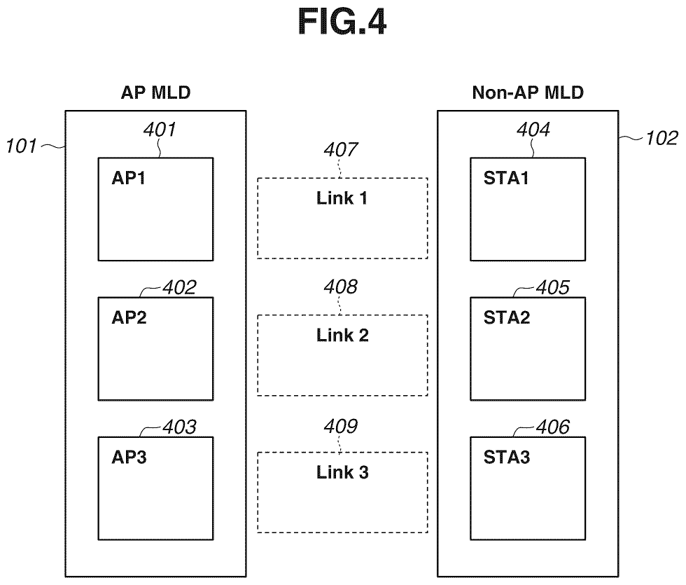

FIG. 4 illustrates an overview of Multi-Link communication performed by the AP MLD 102 and the Non-AP MLD 101 according to the present exemplary embodiment.

A communication apparatus operating in Multi-Link communication is referred to as Multi-Link Device (MLD). One MLD includes a plurality of STAs and a plurality of access points (APs) corresponding to different links. An MLD having an AP function is referred to as an AP MLD, and an MLD not having an AP function is referred to as a Non-AP MLD. A communication apparatus having the AP function may participate in a network built by another AP-MLD, without operating as an AP. Such a communication apparatus is also referred to as a Non-AP MLD.

Referring to FIG. 4, an AP1 401 and an STA1 404 establish a Link1 407 via a first frequency channel. Likewise, an AP2 402 and an STA2 405 establish a Link2 408 via a second frequency channel, and an AP3 403 and an STA3 406 establish a Link3 409 via a third frequency channel.

The AP MLD 102 and the Non-AP MLD 101 establish a connection via frequency channels in the sub-GHz, 2.4 GHz, 3.6 GHz, 4.9 GHZ, 5 GHz, 60 GHz, and 6 GHz bands. The AP MLD 102 and the Non-AP MLD 101 maintain the second link connection via the second frequency channel in parallel with the first link connection via the first frequency channel. These MLDs may establish a plurality of connections via different frequency channels in a same frequency band, not connections in different frequency bands.

### First Exemplary Embodiment

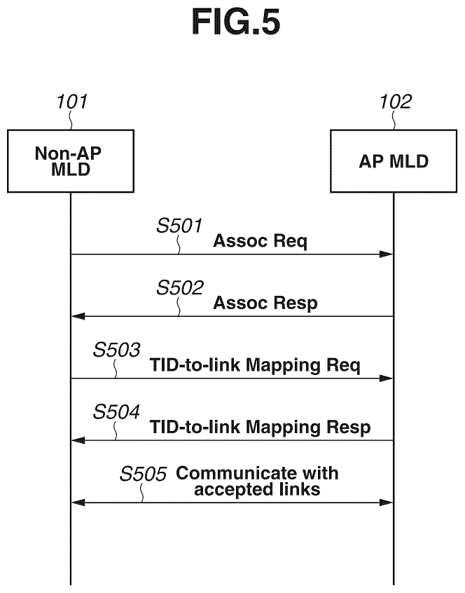

FIG. 5 is a sequence diagram illustrating a link establishment according to the present exemplary embodiment. In step S501, the Non-AP MLD 101 transmits an Association Request to the AP MLD 102. Relevant Association Request not including the TID-To-Link Mapping element (described below) is a frame for requesting the AP MLD 102 for a link establishment. According to the present exemplary embodiment, the Association Request not including the TID-To-Link Mapping element means that the Non-AP MLD 101 once makes an inquiry about the TID assignment proposed by the AP MLD 102.

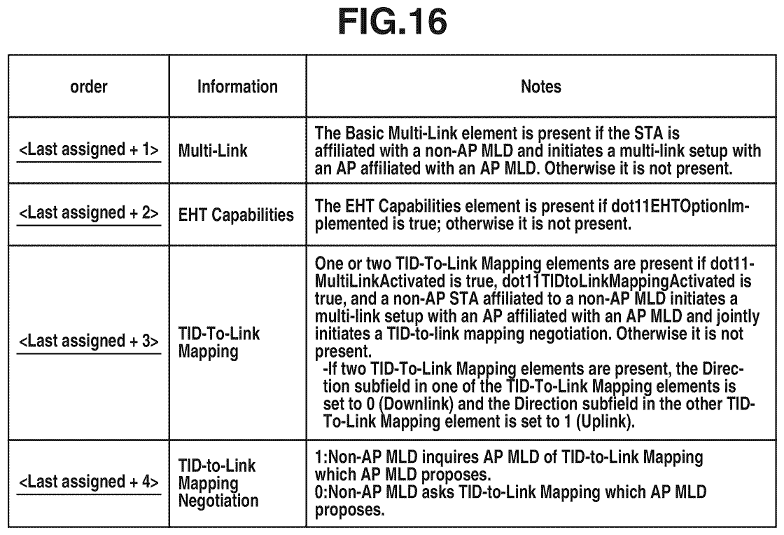

FIG. 16 illustrates a frame body of an Association Request. A case where “0” is stored in the TID-To-Link-Mapping Negotiation field in FIG. 16 may indicate that the Non-AP MLD 101 makes an inquiry about the TID assignment proposed by the AP MLD 102.

A case where “1” is stored in the TID-To-Link-Mapping Negotiation field indicates that the Non-AP MLD 101 follows the TID assignment proposed by the AP MLD 102.

According to the present exemplary embodiment, since the Non-AP MLD 101 makes an inquiry about TID-To-Link-Mapping proposed by the AP MLD 102, the value “0” is stored in the TID-To-Link-Mapping Negotiation field.

When the AP-MLD 102 receives the Association Request, the processing proceeds to step S502. In step S502, the AP-MLD 102 transmits an Association Response to the Non-AP MLD 101. The Association Response is a response to the Association Request.

If the AP MLD 102 transmits a response not including the TID-To-Link Mapping element in step S502, the AP MLD 102 sets the default TID assignment for assigning all TID values to all links. If the default TID assignment is set, the communication apparatuses do not perform a negotiation in steps S503 and S504 (described below), and communication is enabled with the proposed links in step S505.

In contrast, if the AP-MLD 102 transmit a response including the TID-To-Link Mapping element, PREFERRED_TID_TO_LINK_MAPPING_SUGGESTED is set to the Status Code of the relevant response.

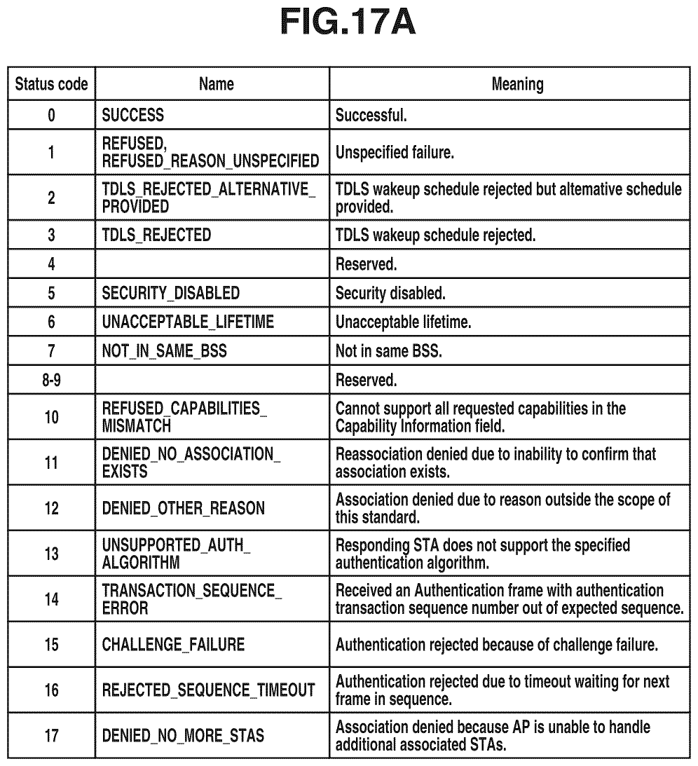

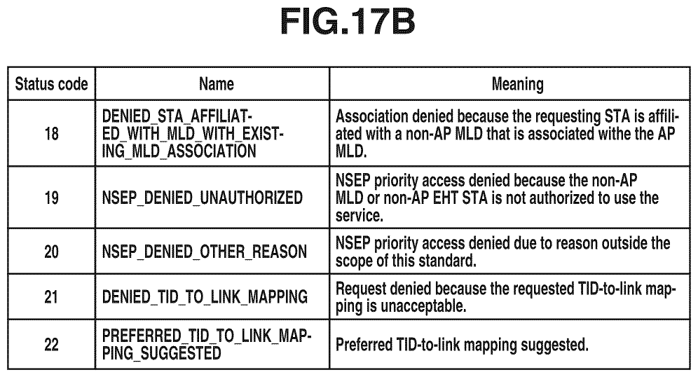

FIGS. 17A and 17B illustrate a list of Status Codes. Status Code “22” in FIG. 17B is associated with “PREFERRED_TID_TO_LINK_MAPPING_SUGGESTED”.

While, according to the present exemplary embodiment, a Status Code is assigned a numeric value from 0 to 22 associated with different meanings of Status, the numeric values of the Status Code is not limited thereto.

When the Non-AP MLD 101 receives the Association Response, the processing proceeds to step S503. In step S503, the Non-AP MLD 101 transmits a TID-To-Link Mapping Request to the AP MLD 102. In this case, if the Non-AP MLD 101 accepts the TID assignment included in the Association Response, the Non-AP MLD 101 includes the TID-To-Link Mapping element received in step S502, in the TID-To-Link Mapping Request.

If the Non-AP MLD 101 rejects the TID assignment proposed by the AP MLD 102, in contrast, the Non-AP MLD 101 transmits the TID-To-Link Mapping Request including the TID assignment proposed by the Non-AP MLD 101. In this case, the TID assignment proposed by the AP MLD 102 is included in the TID-To-Link Mapping element of the TID-To-Link Mapping Request.

When the AP MLD 102 receives the TID-To-Link Mapping Request, the processing proceeds to step S504. In step S504, the AP MLD 102 transmits a TID-To-Link Mapping Response to the Non-AP MLD 101. In this case, if the AP MLD 102 entirely accepts the request of the Non-AP MLD 101, the AP MLD 102 sets SUCCESS to a Status Code and then transmits the relevant response not including the TID-To-Link Mapping element. More specifically, the AP MLD 102 sets “0” to the Status Code illustrated in FIG. 17A and then transmits the TID-To-Link Mapping Response.

If the AP MLD 102 rejects the request of the Non-AP MLD 101, in contrast, the AP MLD 102 sets DENIED_TID_TO_LINK_MAPPING or PREFERRED_TID_TO_LINK_MAPPING_SUGGESTED to the Status Code. More specifically, the AP MLD 102 sets “21” or “22” to the Status Code illustrated in FIG. 17B and transmits the TID-To-Link Mapping Response.

If the AP-MLD 102 accepts at least a part of the TID assignment, the processing proceeds to step S506. In step S506, communication using the relevant links is enabled.

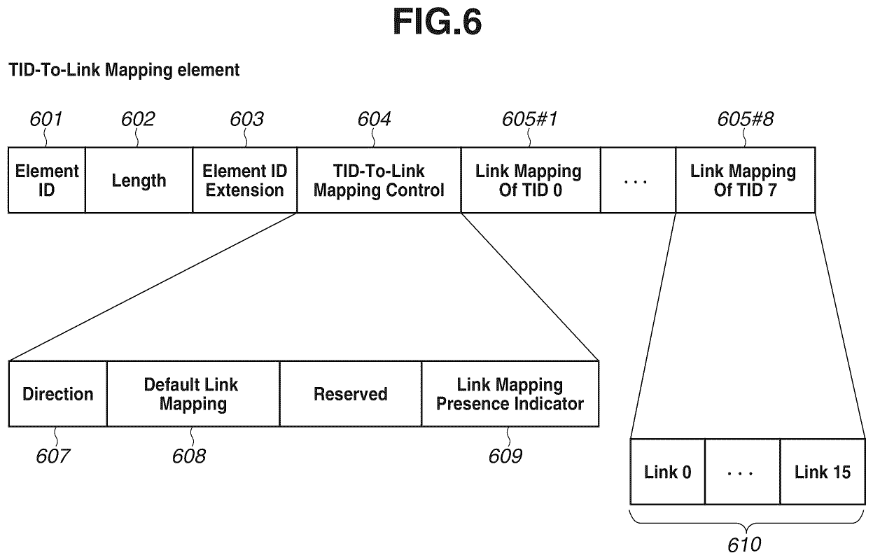

FIG. 6 illustrates an example of a frame format of the TID-To-Link Mapping element according to the present exemplary embodiment. Although the present exemplary embodiment assumes the name of the element illustrated in FIG. 6 as “TID-To-Link Mapping element”, the present invention is not limited thereto and other names are also applicable. This element is stored in management frames, such as the Association Request frame and the Association Response frame. This element is also stored in action frames, such as a TID-To-Link Mapping Request frame and a TID-To-Link Mapping Response frame (described below).

The TID-To-Link Mapping element includes Element ID 601, Length 602, Element ID Extension 603, and TID-To-Link Mapping Control 604. The TID-To-Link Mapping element further includes Link Mapping Of TID 605 (Link Mapping Of TID 0 605 #1 to Link Mapping Of TID 7 605 #8).

TID-To-Link Mapping Control 604 includes Direction 607, Default Link Mapping 608, and Link Mapping Presence Indicator 609.

Direction 607 is a field indicating the upload (UL) or download (DL) direction. Default Link Mapping 608 is a field indicating that the TID assignment is performed in a default mode. The default mode refers to a mode for assigning all TID values to all links.

Link Mapping Presence Indicator 609 is a field indicating whether Link Mapping Of TID 605 is included in this element. If Link Mapping Of TID 605 is not included in this element, Link Mapping Presence Indicator 609 may not be included in the element.

Each of the Link Mapping Of TID 0 605 #1 to Link Mapping Of TID 7 605 #8 is a field indicating which link each TID value is assigned to. These fields are generated for the number of TID values. More specifically, since there are eight different TID values “0” to “7”, as described above, the Link Mapping Of TID 605 includes eight different fields of Link Mapping Of TID 0 605 #1 to Link Mapping Of TID 7 605 #8.

Link Mapping Of TID 605 will be described in more detail below with reference to Link Mapping Of TID 7 605 #8. Link Mapping Of TID 7 605 #8 includes bits 610 including the same number of bits as the number of established links (up to 16 links). The value of each bit indicates whether each link is assigned to TID “7”. Assume an example case where links “1” to “3” are established, and TID “7” is to be assigned to links “1” and “3”. In this case, values 1, 0, and 1 are stored in the bits corresponding to links “1”, “2”, and “3”, respectively, in Link Mapping Of TID 7 605 #8.

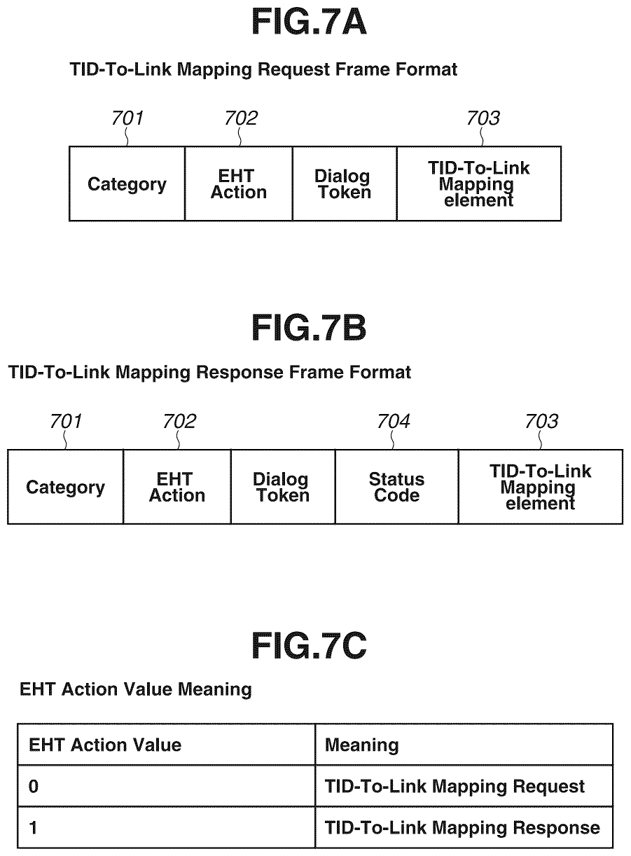

FIGS. 7A, 7B, and 7C indicate examples of the TID-To-Link Mapping Request frame and the TID-To-Link Mapping Response frame as action frames.

FIG. 7A illustrates an example configuration of the TID-To-Link Mapping Request frame.

The TID-To-Link Mapping Request frame includes Category 701, EHT Action 702, Dialog Token, and the TID-To-Link Mapping element 703.

Category 701 is a field indicating that the TID-To-Link Mapping Request frame is the Protected EHT action frame.

The type of the action frame, more specifically, EHT Action Value illustrated in the table in FIG. 7C, is stored in EHT Action 702. The value “0” stored in EHT Action 702 indicates the TID-To-Link Mapping Request frame. According to the present exemplary embodiment, the value “0” is stored to indicate the TID-To-Link Mapping Request frame. However, the present invention is not limited thereto, and other values are also applicable.

The TID-To-Link Mapping element 703 stores the TID-To-Link Mapping element illustrated in FIG. 6. According to the present exemplary embodiment, the TID-To-Link Mapping element in FIG. 6 is stored, but the present invention is not limited thereto. For example, at least a part of information about the TID-To-Link Mapping element illustrated in FIG. 6 may be included.

FIG. 7B illustrates an example configuration of the TID-To-Link Mapping Response frame. The TID-To-Link Mapping Response frame is a response frame corresponding to the TID-To-Link Mapping Request frame.

The TID-To-Link Mapping Response frame includes Category 701, EHT Action 702, Dialog Token, Status Code 704, and the TID-To-Link Mapping element 703.

The fields 701 and 703 overlap with the above-described TID-To-Link Mapping Request frame, and thus redundant descriptions thereof will be omitted.

If EHT Action Value “1” illustrated in the table in FIG. 7C is stored in the EHT Action 702, this indicates that the frame is the TID-To-Link Mapping Response frame.

Status Code 704 indicates a response to the request indicated in the TID-To-Link Mapping Request frame. The Status information illustrated in FIGS. 17A and 17B is stored in Status Code 704.

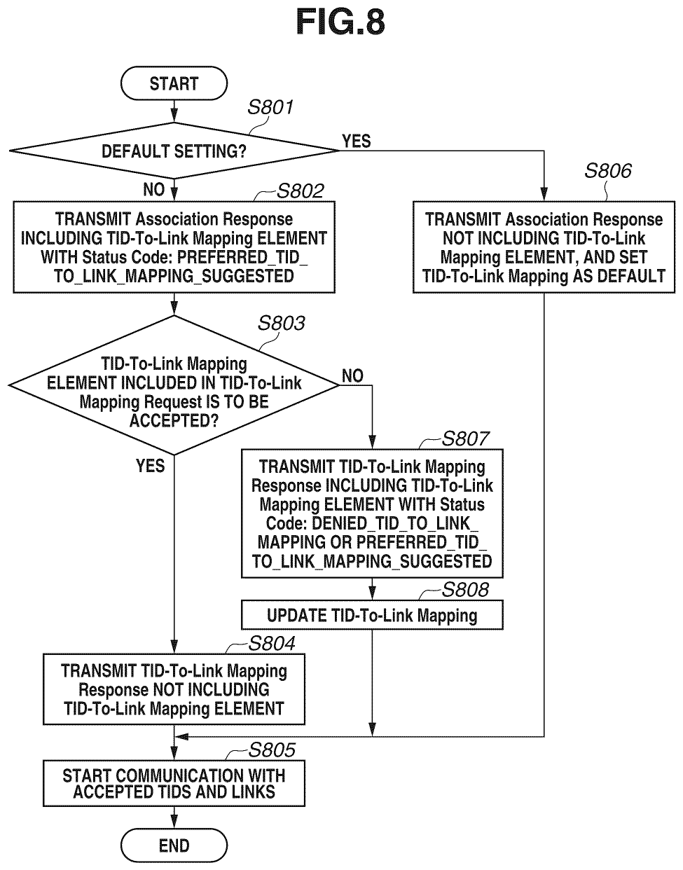

Processing of the TID and link assignment implemented when the control unit 202 executes a program stored in the storage unit 201 of the communication apparatus operating as the AP MLD 102 will be described below with reference to FIG. 8. This flowchart is started when the Non-AP MLD 101 receives the Association Request in step S501 in FIG. 5.

In step S801, the AP MLD 102 determines whether to perform the TID assignment in the default mode. The default mode refers to a mode for assigning all TID values to all links. More specifically, the AP MLD 102 checks whether to perform the TID assignment in the default mode with the setting of the AP MLD 102.

The AP MLD 102 may determine, before step S801, whether the Association Request includes the TID-To-Link Mapping element. If the relevant request includes the TID-To-Link Mapping element, the AP MLD 102 determines whether to accept the proposed TID assignment.

If the AP MLD 102 accepts the TID assignment, the AP MLD 102 assigns the accepted TID values to links to enable communication with the relevant links. If the AP MLD 102 does not accept the TID assignment, the AP MLD 102 may transmit an Association Response including the TID-To-Link Mapping element.

If the AP MLD 102 performs the TID assignment in the default mode (YES in step S801), the processing proceeds to step S806. In step S806, the AP MLD 102 transmits an Association Response not including the TID-To-Link Mapping element. In step S805, the AP MLD 102 assigns the TID values to links in the default mode and then starts communication with the relevant links. Then, the processing exits the flowchart.

In contrast, if the AP MLD 102 does not perform the TID assignment in the default mode (NO in step S801), the processing proceeds to step S802. In step S802, the AP MLD 102 transmits the Association Response including the TID-To-Link Mapping element. In this case, the AP MLD 102 sets “22” corresponding to “PREFERRED_TID_TO_LINK_MAPPING_SUGGESTED” illustrated in FIG. 17B to the Status Code of the Association Response.

In a case where the AP MLD 102 receives the TID-To-Link Mapping Request, the AP MLD 102 determines, in step S803, whether to accept the TID-To-Link Mapping element included in the relevant request.

If the AP MLD 102 accepts the TID-To-Link Mapping element (YES in step S803), the processing proceeds to step S804. In step S804, the AP MLD 102 transmits a TID-To-Link Mapping Response not including the TID-To-Link Mapping element. In step S805, the AP MLD 102 assigns the accepted TID values to links and then starts communication with the relevant links. The processing then exits the flowchart.

Although the AP MLD 102 transmits the TID-To-Link Mapping Response not including the TID-To-Link Mapping element in step S804, the present invention is not limited thereto. For example, the AP MLD 102 may transmit a TID-To-Link Mapping Response including information similar to the TID-To-Link Mapping element included in the TID-To-Link Mapping Request.

If the AP MLD 102 does not accept the TID-To-Link Mapping element (NO in step S803), the processing proceeds to step S807. In step S807, the AP MLD 102 sets “DENIED_TID_TO_LINK_MAPPING” to the Status Code. Alternatively, the AP MLD 102 sets “PREFERRED_TID_TO_LINK_MAPPING_SUGGESTED” to the Status Code. More specifically, the AP MLD 102 sets “21” that corresponds to “DENIED_TID_TO_LINK_ MAPPING” or “PREFERRED_TID_TO_LINK_MAPPING_SUGGESTED” in FIG. 17B to the Status Code. Alternatively, the AP MLD 102 sets “22” corresponding to “PREFERRED_TID_TO_LINK_MAPPING_SUGGESTED” to the Status Code. In step S807, the AP MLD 102 also transmits a TID-To-Link Mapping Response including the set Status Code.

In step S807, if the AP MLD 102 transmits the TID-To-Link Mapping Response, the processing proceeds to step S808. In step S808, the AP MLD 102 updates TID-To-Link Mapping. More specifically, in the processing for updating TID-To-Link Mapping in step S808, the AP MLD 102 performs the TID assignment in the default mode or performs the negotiation for the TID assignment by re-executing steps S503 and S504 in FIG. 5.

In step S808, the AP MLD 102 updates TID-To-Link Mapping. In step S805, the AP MLD 102 assigns the updated TID values to links and then starts communication with the relevant links. Then, the processing exits the flowchart.

Although, in the sequence according to the present exemplary embodiment, the TID-To-Link Mapping element is not supplied to the Association Request, the present invention is not limited thereto. For example, this sequence can be performed even if the TID-To-Link Mapping element is not supplied to the TID-To-Link Mapping Request of the action frame conforming to IEEE 802.11.

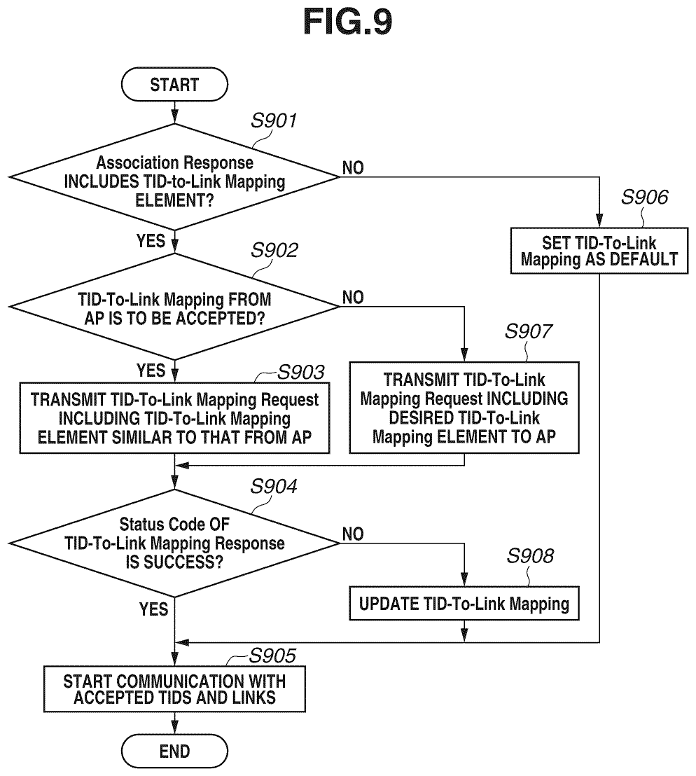

Processing for the TID and link assignment implemented when the control unit 202 executes a program stored in the storage unit 201 of the communication apparatus operating as the Non-AP MLD 101 will be described below with reference to FIG. 9. This flowchart starts when the Non-AP MLD 101 transmits the Association Request illustrated in step S501 in FIG. 5 and then receives the Association Response illustrated in step 502.

In step S901, the Non-AP MLD 101 determines whether the received Association Response includes the TID-To-Link Mapping element.

If the Non-AP MLD 101 determines that the received Association Response does not include the TID-To-Link Mapping element (NO in step S901), the processing proceeds to step S906. In step S906, the Non-AP MLD 101 sets TID-To-Link Mapping as a default. In step S905, the AP MLD 102 starts communication with the links accepted by the AP MLD 102.

If the received Association Response includes the TID-To-Link Mapping element (YES in step S901), the processing proceeds to step S902. In step S902, the Non-AP MLD 101 determines whether to accept TID-To-Link Mapping from the AP MLD 102.

If the Non-AP MLD 101 determines to accept TID-To-Link Mapping (YES in step S902), the processing proceeds to step S903. In step S903, the Non-AP MLD 101 transmits the TID-To-Link Mapping Request including an element similar to the TID-To-Link Mapping element.

If the Non-AP MLD 101 does not accept TID-To-Link Mapping from the AP MLD 102 (NO in step S902), the processing proceeds to step S907. In step S907, the Non-AP MLD 101 transmits the TID-To-Link Mapping Request including the desired TID assignment.

When the Non-AP MLD 101 receives the TID-To-Link Mapping Response as a response to the TID-To-Link Mapping Request transmitted in step S903 or S907, the processing proceeds to step S904. In step S904, the Non-AP MLD 101 checks the Status Code of the relevant frame.

More specifically, the Non-AP MLD 101 determines whether the Status Code illustrated in FIG. 17A is “0” that corresponds to “SUCCESS”. If the Non-AP MLD 101 determines that the Status Code is SUCCESS (YES in step S904), the processing proceeds to step S905. In step S905, the Non-AP MLD 101 starts communication based on the accepted TID assignment. If the Non-AP MLD 101 determines that the Status Code is not SUCCESS (NO in step S904), the processing proceeds to step S908. In step S908, the Non-AP MLD 101 updates TID-To-Link Mapping, and starts, in step S905, communication based on the accepted TID assignment. In the processing for updating TID-To-Link Mapping in step S908, the Non-AP MLD 101 performs, more specifically, the TID assignment as a default, or execute steps S503 and S504 in FIG. 5 again to accept the request for the TID assignment.

The processing may also be applied to a case where, after completion of the TID and link assignment, the Non-AP MLD 101 issues the TID-To-Link-Mapping Request for the TID assignment again with the TID-To-Link-Mapping element not supplied to the relevant request.

According to the present exemplary embodiment, if TID-To-Link Mapping is not supplied to the Association Request, the AP MLD 102 and the Non-AP MLD 101 perform negotiation for the TID assignment. Thus, the AP MLD 102 can suitably perform the TID assignment to the links even if TID-To-Link Mapping is not supplied to the Association Request.

### Second Exemplary Embodiment

The first exemplary embodiment has been described above centering on an example where the AP MLD 102 and the Non-AP MLD 101 perform negotiation for the TID assignment by using the TID-To-Link Mapping Request/Response when TID-To-Link Mapping is not supplied. According to the present exemplary embodiment, the AP MLD 102 and the Non-AP MLD 101 perform negotiation for the TID assignment by using the TID-To-Link Mapping Response without using the TID-To-Link Mapping Request.

Relevant Association Request does not include the TID-To-Link Mapping element like the first exemplary embodiment. According to the present exemplary embodiment, the Association Request not including the TID-To-Link Mapping element means that the Non-AP MLD 101 makes an inquiry about the TID assignment proposed by the AP MLD 102.

According to the present exemplary embodiment, like the first exemplary embodiment, the value “0” stored in the TID-To-Link-Mapping Negotiation field illustrated in FIG. 16 indicates that the Non-AP MLD 101 once makes an inquiry about the TID assignment proposed by the AP MLD 102.

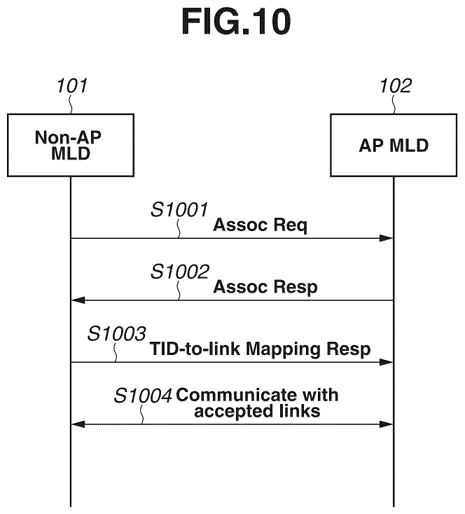

FIG. 10 is a sequence diagram illustrating a link establishment according to the present exemplary embodiment. Steps S1001 and S1002 in FIG. 10 are similar to steps 501 and 502, respectively, according to the first exemplary embodiment, and thus redundant descriptions thereof will be omitted.

When the Non-AP MLD 101 receives an Association Response, the processing proceeds to step S1003. In step S1003, the Non-AP MLD 101 transmits a TID-To-Link Mapping Response to the AP MLD 102.

If the Non-AP MLD 101 accepts the request of the AP MLD 102, the Non-AP MLD 101 sets “0” corresponding to “SUCCESS” illustrated in FIG. 17A to the Status Code and then transmits the TID-To-Link Mapping Response. A case where the Non-AP MLD 101 transmits the TID-To-Link Mapping Response means that the Non-AP MLD 101 will accept the request of the AP MLD 102.

In contrast, if the Non-AP MLD 101 rejects the request of the AP MLD 102, the Non-AP MLD 101 sets “DENIED_TID_TO_LINK_MAPPING” or “PREFERRED_TID_TO_LINK_MAPPING_SUGGESTED” to the Status Code. More specifically, the Non-AP MLD 101 sets “21” corresponding to “DENIED_TID_TO_LINK_MAPPING” to the Status Code. Alternatively, the Non-AP MLD 101 sets “22” corresponding to “PREFERRED_TID_TO_LINK_MAPPING_SUGGESTED” to the Status Code. The Non-AP MLD 101 transmits the TID-To-Link Mapping Response with “21” or “22” set to the Status Code.

If at least a part of the TID assignment is accepted by the AP-MLD 102, the processing proceeds to step S1004. In step S1004, the Non-AP MLD 101 and the AP MLD 102 can communicate with each other by using the relevant links.

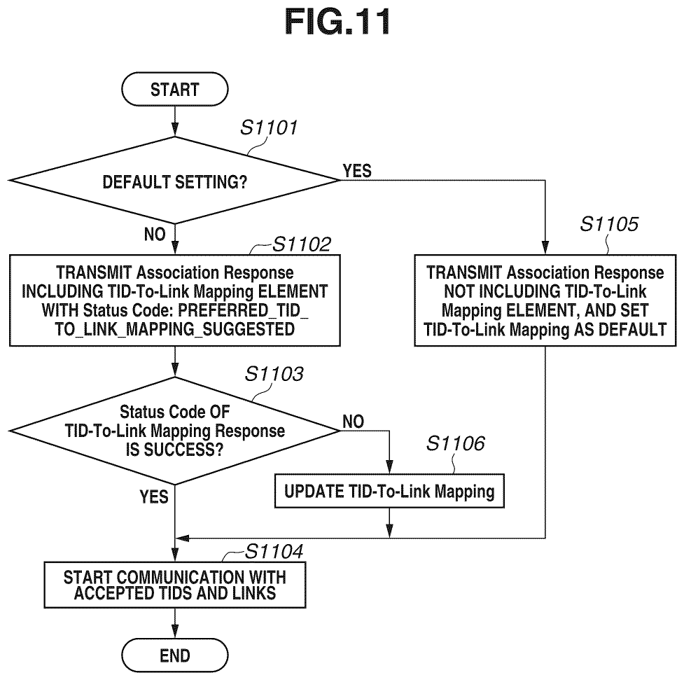

FIG. 11 illustrates processing of the TID and link assignment implemented when the control unit 202 executes a program stored in the storage unit 201 of the communication apparatus operating as the AP MLD 102. The flowchart in FIG. 11 is a modification of that in FIG. 8.

This flowchart starts when the AP MLD 102 receives the Association Request in step S1001 in FIG. 10. Steps S1101, S1102, and S1105 are similar to steps S801, S802, and S806 in FIG. 8, respectively, and thus redundant descriptions thereof will be omitted.

In step S1103, the AP MLD 102 determines whether the Status Code of the received TID-To-Link-Mapping Response is SUCCESS. More specifically, the AP MLD 102 determines whether the Status Code illustrated in FIG. 17A is “0”. If the Status Code is SUCCESS (YES in step S1103), the processing proceeds to step S1104. If the Status Code is not SUCCESS (NO in step S1103), the processing proceeds to step S1106.

If the Status Code is SUCCESS (YES in step S1103), the processing proceeds to step S1104. In step S1104, the AP MLD 102 assigns the accepted TID values to links and then starts communication with the relevant links. The processing then exits the flowchart.

If the Status Code is not SUCCESS (NO in step S1103), the processing proceeds to step S1106. In step S1106, the AP MLD 102 updates TID-To-Link Mapping. Then in step S1104, the AP MLD 102 starts communication based on the accepted TID assignment. In the processing for updating TID-To-Link Mapping in step S1106, the AP MLD 102 performs the TID assignment in the default mode or performs the negotiation for the TID assignment by re-executing step S1003 in FIG. 10. In step S1106, the AP MLD 102 may execute steps 503 and 504 in FIG. 5 to perform the negotiation about the TID assignment again.

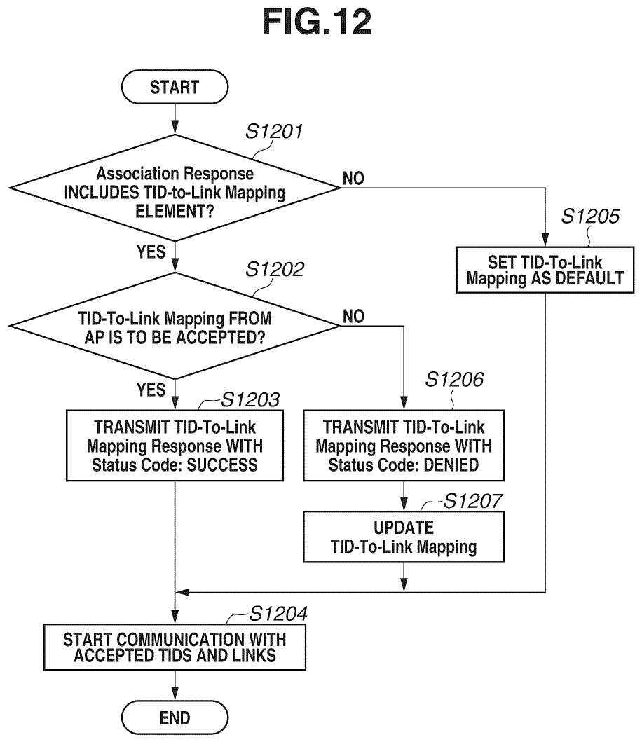

Processing for the TID and link assignment implemented when the control unit 202 executes a program stored in the storage unit 201 of the communication apparatus operating as the Non-AP MLD 101 will be described below with reference to FIG. 12. This flowchart starts after the Non-AP MLD 101 transmits the Association Request in step S1001 illustrated in FIG. 10 and then receives the Association Response in step S1002. The flowchart in FIG. 12 is a modification of that in FIG. 9 and illustrates processing of the TID and link assignment. Steps S1201, S1202, and S1205 are similar to steps S901, S902, and S906 in FIG. 9, respectively, and thus redundant descriptions thereof will be omitted.

In step S1203, if the Non-AP MLD 101 accepts TID-To-Link Mapping, the Non-AP MLD 101 transmits a TID-To-Link-Mapping Response with “SUCCESS” set to the Status Code, to the AP MLD 102. More specifically, the Non-AP MLD 101 transmits the TID-To-Link-Mapping Response with “0” in FIG. 17A set to the Status Code. In step S1204, the Non-AP MLD 101 having transmitted the TID-To-Link-Mapping Response starts communication with AP MLD 102 via the accepted links.

In step S1206 (the case where the Non-AP MLD 101 does not accept TID-To-Link Mapping), the Non-AP MLD 101 transmits TID-To-Link-Mapping Response with “DENIED_TID_TO_LINK_MAPPING” set to the Status Code. More specifically, the Non-AP MLD 101 transmits the TID-To-Link-Mapping Response with “21” in FIG. 17B set to the Status Code.

In step S1207, the Non-AP MLD 101 updates TID-To-Link Mapping. Then in step S1204, the Non-AP MLD 101 starts communication based on the accepted TID assignment. In this case, in the processing for updating TID-To-Link Mapping in step S1207, the Non-AP MLD 101 performs the TID assignment in the default mode or performs the negotiation for the TID assignment by re-executing step S1003. In step S1106, the AP MLD 102 may perform the negotiation for the TID assignment again by re-executing steps S503 and S504 in FIG. 5.

According to the present exemplary embodiment, the AP MLD 102 and the Non-AP MLD 101 perform the negotiation for the TID assignment if TID-To-Link Mapping is not supplied to the Association Request. Thus, the AP MLD 102 can suitably perform the TID assignment to the links even if TID-To-Link Mapping is not supplied to the Association Request.

### Third Exemplary Embodiment

According to the second exemplary embodiment, the AP MLD 102 performs the negotiation for the TID assignment with the TID-To-Link Mapping Response if TID-To-Link Mapping is not supplied to the Association Request.

According to the present exemplary embodiment, the AP MLD 102 transmits TID-To-Link Mapping proposed by the AP MLD 102 to the Non-AP MLD 101, and the Non-AP MLD 101 inevitably follows TID-To-Link Mapping proposed by the AP MLD 102.

According to the present exemplary embodiment, like the first and the second exemplary embodiments, the Association Request does not include the TID-To-Link Mapping element. According to the present exemplary embodiment, the Association Request not including the TID-To-Link Mapping element means that the Non-AP MLD 101 follows the TID assignment determined by the AP MLD 102.

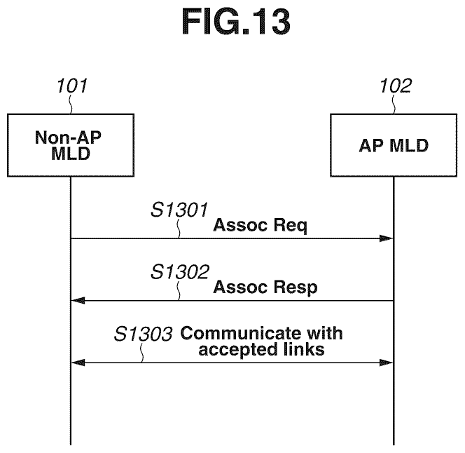

FIG. 13 is a sequence diagram illustrating a link establishment according to the present exemplary embodiment.

In step S1301, the Non-AP MLD 101 transmits the Association Request to the AP MLD 102. The value “1” stored in the TID-To-Link-Mapping Negotiation field in FIG. 16 indicates that the Non-AP MLD 101 follows the TID assignment determined by the AP MLD 102.

When the AP MLD 102 receives the Association Request transmitted from the Non-AP MLD 101, the processing proceeds to step S1302. In step S1302, the AP MLD 102 transmits the Association Response as a response to the Non-AP MLD 101.

The Association Response in step S1302 includes TID-To-Link-Mapping proposed by the AP MLD 102. In this case, the AP MLD 102 sets “22” meaning “PREFERRED_TID_TO_LINK_MAPPING_SUGGESTED” illustrated in FIG. 17B to the Status Code.

When the Non-AP MLD 101 receives the Association Response, the processing proceeds to step S1303. In step S1303, the Non-AP MLD 101 starts communication with the AP MLD 102 via the accepted link. According to the present exemplary embodiment, the Non-AP MLD 101 inevitably accepts TID-To-Link Mapping determined by the AP MLD 102.

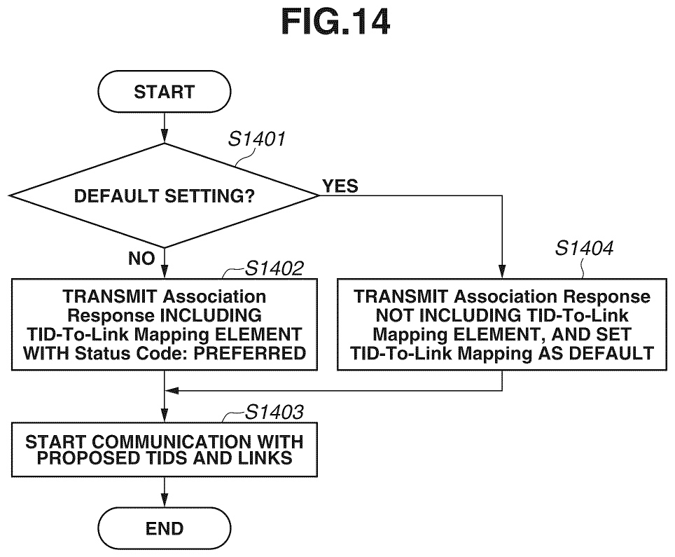

Processing for the TID and link assignment is implemented when the control unit 202 executes a program stored in the storage unit 201 of the communication apparatus operating as the AP MLD 102. This processing will be described below with reference to FIG. 14.

This flowchart starts when the Non-AP MLD 101 receives the Association Request illustrated in step S1301 in FIG. 13. The flowchart in FIG. 14 is a modification of that in FIG. 8. Steps S1401 and S1404 are similar to steps S801 and S806 in FIG. 8, respectively, and redundant descriptions thereof will be omitted.

If the AP MLD 102 does not perform the TID assignment in the default mode (NO in step S1401), the processing proceeds to step $1402. In step S1402, the AP MLD 102 transmits the Association Response including the TID-To-Link Mapping element proposed by the AP MLD 102. In this case, the AP MLD 102 sets “22” meaning “PREFERRED_TID_TO_LINK_MAPPING_SUGGESTED” illustrated in FIG. 17B to the Status Code.

According to the present exemplary embodiment, the Non-AP MLD 101 inevitably receives TID-To-Link Mapping proposed by the AP MLD 102. In step S1403, the AP MLD 102 therefore assigns TID-To-Link Mapping proposed by the AP MLD 102 to the links and then starts communication. When the AP MLD 102 starts communication in step S1403, the processing exits this flowchart.

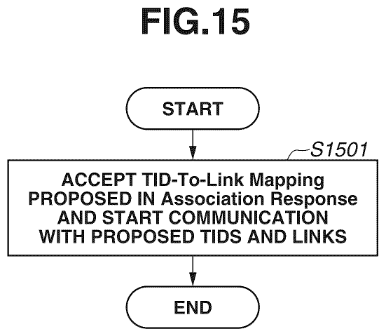

Processing for the TID and link assignment is implemented when the control unit 202 executes a program stored in the storage unit 201 of the communication apparatus operating as the Non-AP MLD 101. This processing will be described below with reference to FIG. 15. This flowchart starts when the Non-AP MLD 101 transmits the Association Request illustrated in step S1301 in FIG. 13 and then receives the Association Response illustrated in step S1002.

According to the present exemplary embodiment, the Non-AP MLD 101 inevitably accepts TID-To-Link Mapping proposed by the AP MLD 102. In step S1501, the AP MLD 102 accepts TID-To-Link Mapping included in the received Association Response and starts communication. The processing then exits the flowchart.

According to the present exemplary embodiment, if TID-To-Link Mapping is not supplied to the Association Request, the Non-AP MLD 101 follows the TID assignment proposed by the AP MLD 102 to enable the TID assignment.

### Other Exemplary Embodiments

A recording medium storing a program code of software for implementing the above-described functions may be supplied to a system or an apparatus, and the computer (CPU or MPU) of the system or the apparatus may read and execute the program code stored in the recording medium. In this case, the program code itself read from the storage medium implements the functions of the above-described exemplary embodiments, and the storage medium storing the program code configures the above-described apparatus.

Examples of usable storage media for supplying the program code include a flexible disk, a hard disk, an optical disc, a magneto-optical disk, a CD-ROM, a CD-R, a magnetic tape, a nonvolatile memory card, a ROM, and a DVD.

The above-described functions may be implemented not only when the computer executes the read program code but also when an operating system (OS) operating on the computer executes part or whole of actual processing based on instructions of the program code.

Further, the program code read from the storage medium is written to a memory included in a function expansion board inserted into the computer or a function expansion unit connected to the computer. The CPU included in the function expansion board or the CPU in the function expansion unit may implement the above-described functions by executing part or whole of actual processing based on instructions of the program code.

The present invention can also be achieved when a program for implementing at least one of the functions according to the above-described exemplary embodiments is supplied to a system or an apparatus via a network or a storage medium, and at least one processor in the computer of the system or the apparatus reads and executes the program. Further, the present invention can also be achieved by a circuit such as an application specific integrated circuit (ASIC) for implementing at least one function.

The present invention is not limited to the above-described exemplary embodiments but can be modified and changed in diverse ways without departing from the spirit and scope thereof. Therefore, the following claims are appended to disclose the scope of the present invention.

The present invention makes it possible to provide a method for suitably assigning TID values to links.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus capable of establishing a plurality of links with another communication apparatus in parallel, the communication apparatus comprising:
a reception unit configured to receive a request including information about a link establishment; and
a transmission unit configured to transmit a response to the request received by the reception unit,
wherein, in a case where the request received by the reception unit does not include information about an assignment of a traffic identifier (TID) indicating data priority, the transmission unit transmits a response including the information about the assignment of the TID.

2. The communication apparatus according to claim 1, wherein the request and the response are management frames conforming to an Institute of Electrical and Electronic Engineers (IEEE) 802.11 standard.

3. The communication apparatus according to claim 1, wherein the request is an association request.

4. The communication apparatus according to claim 1, wherein the response is an association response.

5. A communication apparatus capable of establishing a plurality of links with another communication apparatus in parallel, the communication apparatus comprising:
a transmission unit configured to transmit a request including information about a link establishment but not including information about an assignment of a TID indicating data priority;
a reception unit configured to receive a response to the request transmitted by the transmission unit; and
a communication unit configured to communicate with the other communication apparatus based on the information about the assignment of the TID included in the response received by the reception unit.

6. The communication apparatus according to claim 5, wherein the communication apparatus transmits the request including a setting of a first value to make an inquiry about the assignment of the TID proposed by the other communication apparatus.

7. The communication apparatus according to claim 6, wherein the communication apparatus transmits the request including a setting of a second value different from the first value to follow the assignment of the TID proposed by the other communication apparatus.

8. The communication apparatus according to claim 5, further comprising a unit configured to transmit information about the assignment of the TID to be used by the communication apparatus.

9. The communication apparatus according to claim 5, wherein the request and the response are management frames conforming to the IEEE 802.11 standard.

10. The communication apparatus according to claim 5, wherein the request is an association request.

11. The communication apparatus according to claim 7, wherein the first value and the second value are included in an association request.

12. The communication apparatus according to claim 5, wherein the response is an association response.

13. The communication apparatus according to claim 5, wherein the response includes an TID-To-Link Mapping element that is information about the assignment of the TID.

14. A communication method for a communication apparatus capable of establishing a plurality of links with another communication apparatus in parallel, the communication method comprising:
receiving a request including information about a link establishment;
transmitting a response to the request in the receiving, and
transmitting, in a case where the request in the receiving does not include information about an assignment of a TID indicating data priority, a response including information about the assignment of the TID.

15. A communication method for a communication apparatus capable of establishing a plurality of links with another communication apparatus in parallel, the communication method comprising:
transmitting a request including information about a link establishment but not including information about an assignment of a TID indicating data priority;
receiving a response to the request in the transmitting; and
communicating with the other communication apparatus based on the information about the assignment of the TID included in the response in the receiving.

16. A non-transitory storage medium storing a program for causing a computer to function as each unit of the communication apparatus according to claim 1.
